(19) United States
(12) Patent Application Publication
(10) Pub. No.: US 2013/0258635 A1
(43) Pub. Date: Oct. 3, 2013

(54) INDICATOR DISPLAY DEVICE

(71) Applicant: DENSO CORPORATION, Kariya-city (JP)

(72) Inventor: Takahira Kato, Kariya-city (JP)

(73) Assignee: DENSO CORPORATION, Kariya-city (JP)

(21) Appl. No.: 13/853,167

(22) Filed: Mar. 29, 2013

(30) Foreign Application Priority Data
Apr. 3, 2012 (JP) 2012-085002

(51) Int. Cl. G01D 13/22

(52) U.S. Cl. CPC G01D 13/22
USPC 362/23.02; 362/23.01

(57) ABSTRACT

An indicator display device includes a light source and an indicator. The light source emits a light flux. The indicator is configured to rotate and includes an entrance portion to which the light flux emitted from the light source enters and a shielding portion that blocks transmission of the light flux entering from the entrance portion. The shielding portion has an exit slit from which the light flux entering from the entrance portion is output toward a user. A width b of the exit slit, an assumed distance L between the indicator and the user, and an assumed visual power VP of the user satisfy a relationship of:

b(mm)<L(mm)×tan {1/VP(min)}.

### CROSS REFERENCE TO RELATED APPLICATIONS

The present application is based on and claims priority to Japanese Patent Application No. 2012-85002 filed on Apr. 3, 2012, the contents of which are incorporated in their entirety herein by reference.

### TECHNICAL FIELD

The present disclosure relates to an indicator display device that includes a rotating indicator.

### BACKGROUND

Conventionally, an indicator included in an indicator display device is configured to emit light by outputting a light flux, which is emitted from a light source, toward a user. Japanese Patent No. 4,257,025 discloses an indicator in which a metallic hot stamp layer that blocks transmission of a light flux is formed on a surface of an indicator body made of, for example, acrylic resin. In the above-described indicator, a design section is formed by partially removing the hot stamp layer so that the light flux is output from the design section of the indicator body toward a user.

In the indicator display device including the above-described indicator and a light source that enables the indicator to emit light, when a sufficient light flux is emitted from the light source, the indicator that emits light by outputting the light flux from the design section toward a user is visible to the user. When the light flux from the light source is suppressed, an appearance of the indicator covered by the metallic hot stamp is visible to a user.

When the light flux from the light source is suppressed, the design section formed in the hot stamp layer is clearly visible to a user. Because the design section from which the light flux is output is clearly recognized by a user, a change in the appearance of the indicator by switching a lighting state of the light source is easily predicted by the user.

### SUMMARY

It is an object of the present disclosure to provide an indicator display device having such a configuration that it is difficult for a user to predict a change in appearance of an indicator by changing a lighting state of a light source.

According to an aspect of the present disclosure, an indicator display device includes a light source and an indicator. The light source emits a light flux. The indicator is configured to rotate and includes an entrance portion to which the light flux emitted from the light source enters and a shielding portion that blocks transmission of the light flux entering from the entrance portion. The shielding portion has an exit slit from which the light flux entering from the entrance portion is output toward a user. A width b of the exit slit, an assumed distance L between the indicator and the user, and an assumed visual power VP of the user satisfy a relationship of b(mm)<L(mm)×tan{1/VP(min)}.

According to another aspect of the present disclosure, an indicator display device includes a light source, an indicator, and a light source control section. The light source emits a light flux. The indicator is configured to rotate and includes an entrance portion to which the light flux emitted from the light source enters and a shielding portion that blocks transmission of the light flux entering from the entrance portion, the shielding portion having an exit slit from which the light flux entering from the entrance portion is output toward a user. The light source control section controls an amount of the light flux emitted from the light source so that a light flux density of an output light that is output from the exit slit corresponds to a light flux density of a reflected light that is an outside light reaching the indicator display device and being reflected by the shielding portion.

### BRIEF DESCRIPTION OF THE DRAWINGS

Additional objects and advantages of the present disclosure will be more readily apparent from the following detailed description when taken together with the accompanying drawings. In the drawings:

FIG. 1 is a front view of a combination meter according to a first embodiment of the present disclosure;

FIG. 2 is a cross-sectional view of an indicator taken along line II-II in FIG. 1;

FIG. 3 is a block diagram showing an electrical configuration of the combination meter according to the first embodiment;

FIG. 4 is a flowchart showing a switching process performed by a meter controller;

FIG. 5 is a cross-sectional view of the indicator taken along line V-V in FIG. 1;

FIG. 6 is a diagram for explaining a mechanism of making an exit slit invisible to a user;

FIG. 7 is a timing diagram showing current values applied to light emitting diodes in the combination meter according to the first embodiment;

FIG. 8 is a block diagram showing an electrical configuration of a combination meter according to a second embodiment of the present disclosure;

FIG. 9 is a cross-sectional view of an indicator according to a second embodiment;

FIG. 10 is a timing diagram showing current values applied to light emitting diodes in the combination meter according to the second embodiment;

FIG. 11 is a timing diagram showing current values applied to light emitting diodes in an combination meter according to a third embodiment of the present disclosure;

FIG. 12 is a block diagram showing an electrical configuration of the combination meter according to a fifth embodiment of the present disclosure;

FIG. 13 is a cross-sectional view of an indicator according to another embodiment of the present disclosure; and

FIG. 14 is a cross-sectional view of an indicator according to another embodiment of the present disclosure.

### DETAILED DESCRIPTION

Embodiments of the present disclosure will be described with reference to accompanying drawings. In each of the following embodiments, corresponding components are designated by the same reference numeral and overlapping description will be omitted. In cases where only a part of a configuration is described, a configuration of another embodiment described in advance can be applied to the other part of the configuration. Furthermore, as well as combinations described in the following embodiments, configurations of two or more embodiments can be partially combined with each other unless the combination does not cause a trouble.

### First Embodiment

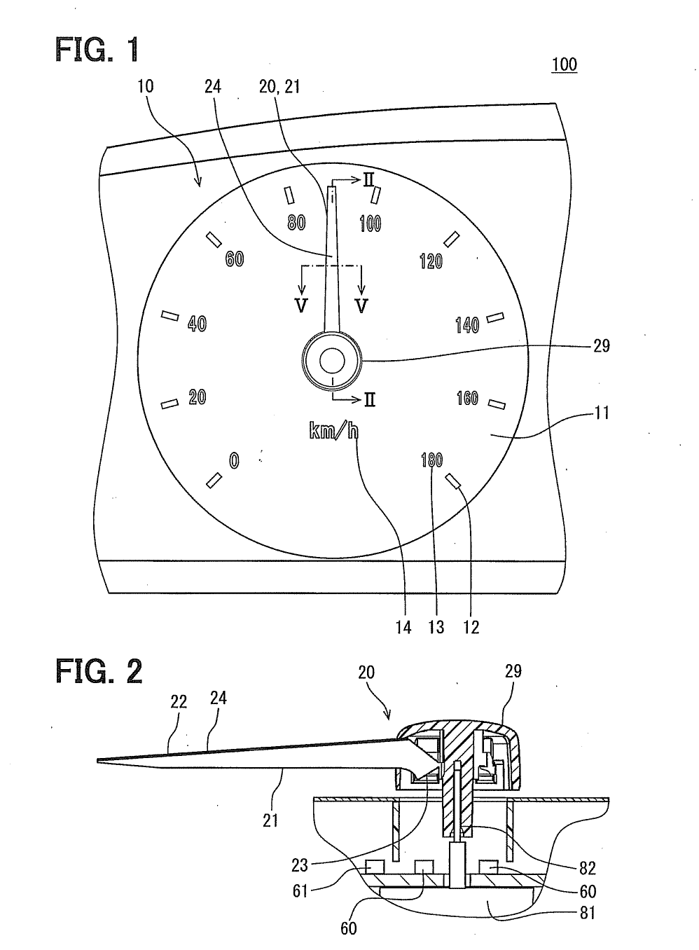

A combination meter 100 according to a first embodiment of the present disclosure is an indicator display device that displays various kinds of information about a vehicle. The combination meter 100 is housed in an instrument panel disposed in an interior of the vehicle in such a manner that a front side shown in FIG. 1 faces a driver seat.

The combination meter 100 includes a speed meter 10 and gauses, such as a tachometer, a water thermometer, and a fuel gauge, which are not shown. The speed meter 10 displays a travel speed of the vehicle, in which the combination meter 100 are mounted, to a user as information. The speed meter 10 displays the information by combining a design section including a scale portion 12, a figure portion 13, and a unit portion 14, which are formed on an indication panel 11, and an indicator 20 that rotates along the indication panel 11.

The indication panel 11 has a disc shape. The indication panel 11 enables the scale portion 12, the figure portion 13, and the unit portion 14 to emit light by transmitting the light in an indication direction from the combination meter 100 toward the driver seat. The scale portion 12 is circularly arranged at a regular interval along an outer edge of the indication panel 11. The figure portion 13 has a shape of Arabic figures for indicating the travel speed of the vehicle. The figure portion 13 is located inside the scale portion 12 in a radial direction. The unit portion 14 has a shape of characters of alphabet and a symbol.

The indicator 20 shown in FIG. 1 and FIG. 2 includes a pointer 21 and a cap 29. The pointer 21 is made of transparent resin, such as acrylic resin. The cap 29 is made of transparent resin. The pointer 21 extends in a radial direction of the indication panel 11 and includes an entrance portion 23 and a colored layer 24. The speed meter 10 includes a light emitting diode 60 located in a rear direction, which is opposite from the indication direction, with respect to the indicator 20. The light emitting diode 60 emits a light flux, and the light flux enters the entrance portion 23. The colored layer 24 is a red printed layer formed on a visible surface 22 of the pointer 21 facing in the indication direction. The colored layer 24 blocks transmission of the light flux that enters the pointer 21 from the entrance portion 23. The colored layer 24 defines an exit slit 26 (see FIG. 5) through which the light flux entering from the entrance portion 23 is output in the indication direction. Accordingly, the indicator 20 emits light by outputting the light flux from the pointer 21 in the indication direction.

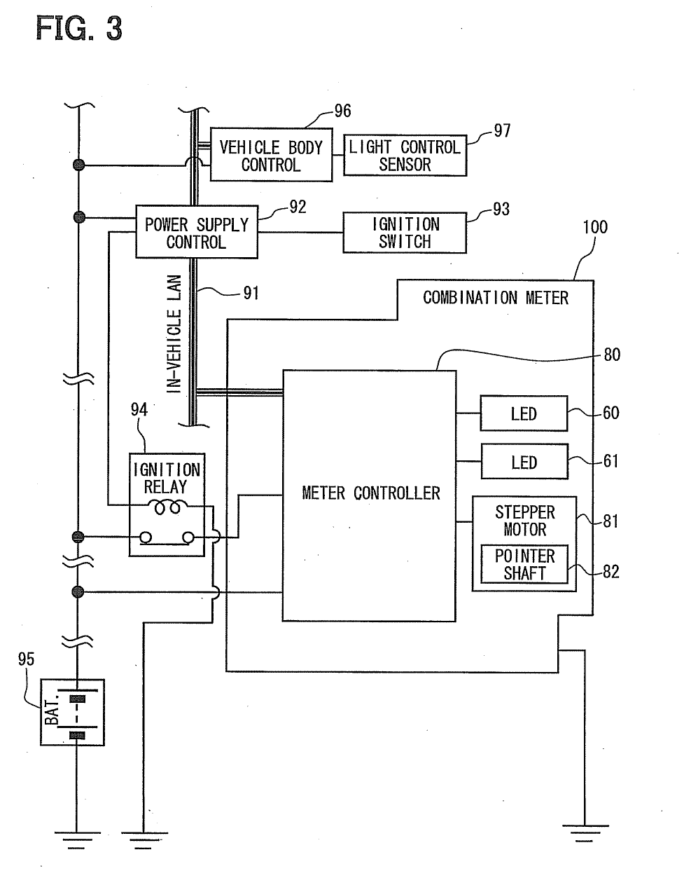

Next, an electrical configuration of the combination meter 100 will be described with reference to FIG. 3.

The combination meter 100 is electrically configured by, for example, a meter controller 80, the light emitting diodes 60, 61, and a stepper motor 81. Furthermore, the combination meter 100 is coupled with an external battery 95, an in-vehicle local area network (in-vehicle LAN) 91, and a grounding wire that is grounded.

The meter controller 80 includes a microcomputer that operates based on programs. The meter controller 80 is supplied with electric power from the battery 95. The meter controller 80 is coupled with the in-vehicle LAN 91. The in-vehicle LAN 91 includes a power supply control circuit 92 and a vehicle body control circuit 96. When the power supply control circuit 92 detects a pressing operation of an ignition switch 93 by a user, the power supply control circuit 92 applies a voltage to an ignition relay 94 to energize the ignition relay 94. Furthermore, based on the detected pressing operation of the ignition switch 93, the power supply control circuit 92 transmits information about an on-off state of an ignition of the vehicle to the in-vehicle LAN 91. The vehicle body control circuit 96 is coupled with a light control sensor 97 that detects an outside light amount around the vehicle. The vehicle body control circuit 96 transmits information about a day-and-night determination based on a detection result of the light control sensor 97 and information about the outside light amount detected by the light control sensor 97. The meter controller 80 receives the information about the on-off state of the ignition, the information about the day-and-night determination, the information about the outside light amount, and the information about the travel speed of the vehicle, which are transmitted to the in-vehicle LAN 91.

The meter controller 80 is coupled with the light emitting diodes 60, 61 and the stepper motor 81. The light emitting diode 60 emits light having a hue similar to a hue of the colored layer 24 (see FIG. 2). The light emitting diode 61 emits a light flux to enable the scale portion 12, the figure portion 13, and the unit portion 14 to emit light. The meter controller 80 controls the amount of light flux emitted from each of the light emitting diodes 60, 61 by increasing and decreasing a current value applied to each of the light emitting diodes 60, 61. In addition, the meter controller 80 drives a pointer shaft 82 fitted in the indicator 20 (see FIG. 2) by applying a pulse voltage to the stepper motor 81 based on the information about the travel speed of the vehicle.

When the ignition of the vehicle is turned on based on the pressing operation of the ignition switch 93, the ignition relay 94 becomes an energized state by being applied with the voltage. Then, the combination meter 100 starts a light emission control of each of the light emitting diodes 60, 61 shown in FIG. 3 and a rotation control of the pointer shaft 82 so that the speed meter 10 makes an indication in accordance with the travel speed of the vehicle as shown in FIG. 1.

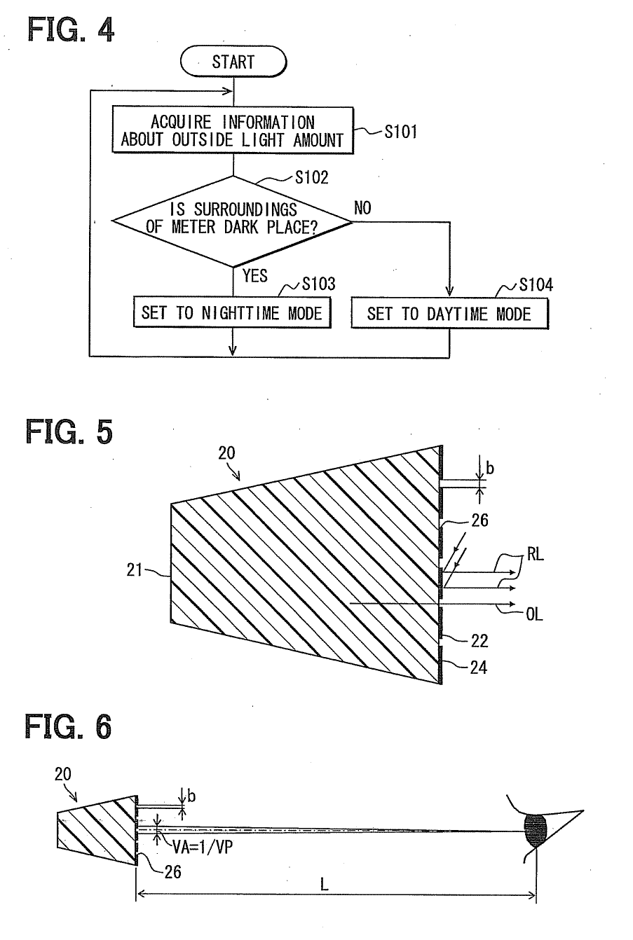

In addition, the combination meter 100 switches the light emission control of each of the light emitting diodes 60, 61 between a nighttime mode and a daytime mode based on the day-and-night determination by the vehicle body control circuit 96. The nighttime mode is a lighting mode appropriate in a state where the amount of the outside light that reaches the combination meter 100 is small. In contrast, the daytime mode is a lighting mode appropriate in a state where the amount of the outside light that reaches the combination meter 100 is large. A switching process for switching the lighting modes will be described with reference to FIG. 4. The meter controller 80 starts the switching process shown in FIG. 4 when the meter controller 80 receives the information that the ignition of the vehicle is turned on. The meter controller 80 repeats the switching process until the ignition of the vehicle is turned off.

At S101, the meter controller 80 acquires the information about the day-and-night determination and the information about the amount of the outside light as the information relating to the amount of the outside light that reaches the combination meter 100, through the in-vehicle LAN 91. At S102, the meter controller 80 indirectly determines whether surroundings of the combination meter 100 is a dark place where the amount of the outside light is small, based on the information about the day-and-night determination acquired at S101. If the meter controller 80 makes an affirmative determination that the surroundings of the combination meter 100 is a dark place based on the night determination by the vehicle body control circuit 96 (S102: YES), the meter controller 80 proceeds to S103 and sets the lighting mode of the combination meter 100 to the nighttime mode. If the meter controller 80 makes a negative determination that the surroundings of the combination meter 100 is not a dark place (S102: NO) based on a day determination by the vehicle body control circuit 96, the meter controller 80 proceeds to S104 and sets the lighting mode of the combination meter 100 to the daytime mode. After the meter controller 80 sets the lighting mode at S103 or S104, the meter controller 80 returns to S101 and continues the switching process.

A configuration and a manufacturing method of the indicator 20 in the combination meter 100 according to the present embodiment will be described with reference to FIG. 5 and FIG. 6.

The colored layer 24 in the indicator 20 shown in FIG. 5 defines a plurality of exit slits 26. The exit slits 26 are arranged at regular intervals in a width direction of the pointer 21 and extend in a longitudinal direction of the pointer 21.

A width b of each of the exit slits 26 is set to satisfy Expression 1. As shown in FIG. 6, L in Expression 1 is an assumed distance between the indicator 20 and a user, and VP is an assumed visual power of the user.

b(mm)<L(mm)×tan{1/VP(min)}

When the width b of each of the exit slits 26 satisfies Expression 1, each of the exit slits 26 is invisible to the user. The mechanism will be described below. When the visual power of the user is VP, a visual angle VA of the user is 1/VP (min). Thus, the minimum dimension visible to the user at a distance L from the indicator 20 is L×tan{1/VP} (mm). Thus, when the width b of each of the exit slits b is smaller than L×tan{1/VP}, the exit slits 26 are invisible to the user.

For example, the distance L between the indicator and an eye point of a driver as a user is assumed to be 600 (mm) and the visual power VP of the driver is assumed to be 1.0 in decimal notation, which is equivalent to 20/20 in fraction notation. In this case, by setting the-width b of each of the exit slits 26 to be less than 0.175 (mm), the exit slits 26 are invisible to the driver.

The exit slits 26 are formed by irradiating the colored layer 24 shown in FIG. 5 with a laser light. Specifically, the colored layer 24 formed uniformly on the visible surface 22 of the pointer 21 is irradiated with the laser light in accordance with the design of the exit slits 26. A spot diameter of the laser light is set to be smaller than the width b of each of the exit slits 26. By removing a part of the colored layer 24 with the laser light, the exit slits 26 invisible by the user can be formed.

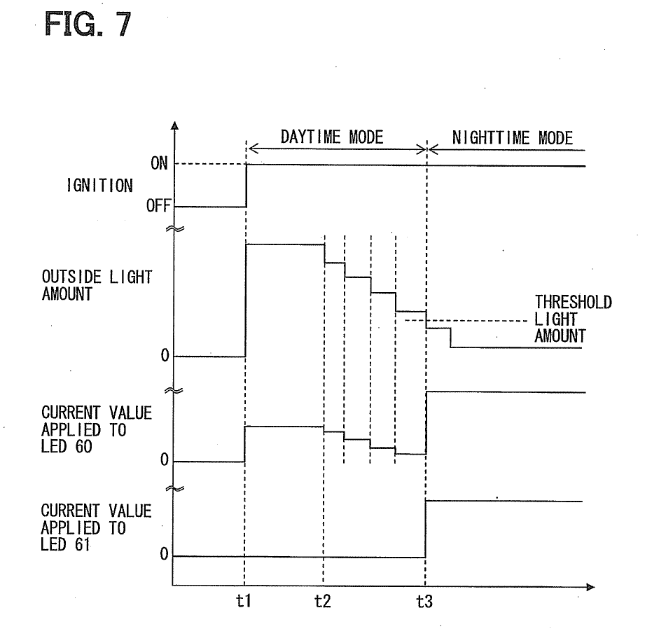

A light control of each of the light emitting diodes 60, 61 in each of the daytime mode and the nighttime mode will be described with reference to FIG. 3 and FIG. 7.

When the ignition of the vehicle is switched from the off-state to the on-state by the operation of the ignition switch 93 (see time t1 in FIG. 7), the meter controller 80 starts to acquire the information on the day-and-night determination and the information on the outside light amount (see S101 in FIG. 4). For example, when the combination meter 100 is set to the daytime mode based on the day determination by the vehicle body control circuit 96, the meter controller 80 controls electric current applied to the light emitting diode 60 based on the information on the outside light amount acquired from the vehicle body control circuit 96 and a predetermined table.

In the table, a relationship between the outside light amount detected by the light control sensor 97 and the current value to be applied to the light emitting diode 60 is defined. In the table, the current value is set to increase with increase in the outside light amount. Thus, the meter controller 80 in the daytime mode increases a light flux amount emitted from the light emitting diode 60 with increase in the outside light amount and decreases the light flux amount emitted from the light emitting diode 60 with decrease in the outside light amount (see time t2 to t3 in FIG. 7). Accordingly, a light flux density of an output light OL output from the exit slit 26 corresponds to a light flux density of a reflected light RL that is the outside light reaching the combination meter 100 and being reflected by the colored layer 24 (see FIG. 5). In the daytime mode, the meter controller 80 stops the application of the electric current to the light emitting diode 61.

When the outside light amount detected by the light control sensor 97 becomes less than a threshold light amount (see time t3 in FIG. 7), the day-and-night determination by the vehicle body control circuit 96 changes from the day determination to the night determination. Accordingly, the meter controller 80 changes the lighting mode from the daytime mode to the nighttime mode. In the, nighttime mode, the meter controller 80 controls the current value applied to the light emitting diode 60 so that the amount of the light flux emitted from the light emitting diode 60 is greater than the amount of the light flux in the daytime mode. In addition, the meter controller 80 starts the application of the electric current to the light emitting diode 61. Accordingly, an indicator display including the indicator 20, which emits light brighter than the daytime mode, and the design section, such as the scale portion 12, the figure portion 13, and the unit portion 14, are formed in the combination meter 100 (see FIG. 1).

In the present embodiment, in the nighttime mode in which a sufficient light flux is emitted from the light emitting diode 60, the indicator 20 that emits light by outputting the output light OL from the exit slits 26 is visible to a user. On the other hand, in the daytime mode in which the emission of the light flux from the light emitting diode 60 is suppressed, it becomes difficult for a user at a distance greater than or equal to L from the indicator 20 and having a visual power less than or equal to VP to view the exit slits 26. Thus, the appearance of the indicator 20 covered with the colored layer 24 as if the exit slits 26 are not formed is visible to the user. Therefore, it is difficult for the user to predict a change in the appearance of the indicator 20 by switching the lighting state of the light emitting diode 60.

In addition, in the present embodiment, the light flux amount emitted from the light emitting diode 60 is controlled so that the light flux density of the output light OL output from the exit slit 26 corresponds to the light flux density of the reflected light RL that is reflected by the colored layer 24. Thus, it becomes more difficult for the user to discriminate the exit slits 26 from the colored layer 24. Because it becomes more difficult for the user to view the exit slits 26, it becomes difficult for the user to predict a change in the appearance of the indicator 20.

Furthermore, in the daytime mode in the present embodiment, the light flux density of the output light OL can accurately follow the change of the light flux density of the reflected light RL, which increases and decreases in accordance with the outside light amount, based on the information on the outside light amount acquired through the in-vehicle LAN 91. Thus, it becomes difficult for the user to view the exit slit 26 regardless of the outside light amount. In the nighttime mode, the meter controller 80 controls the current value so that the light flux amount emitted from the light emitting diode 60 is greater than the light flux amount emitted in the daytime mode. Thus, the indicator 20 emits light brighter than the daytime mode. Accordingly, it becomes more difficult for the user to predict the change in the appearance of the indicator 20 by switching the lighting state of the light emitting diode 60 between the nighttime mode and the daytime mode.

Furthermore, in the present embodiment, the hue of the light flux output from the exit slit 26 corresponds to the hue of the colored layer 24. Thus, it is more difficult for the user to view the exit slits 26 when the light flux density of the output light OL corresponds to the light flux density of the reflected light RL. Therefore, it is more difficult for the user to predict the change in the appearance of the indicator 20.

In the present embodiment, the colored layer 24 can operate as a shielding portion, the light emitting diode 60 can operate as a light source, the meter controller 80 can operate as a light source control section, an outside light amount acquisition section, and a determination section, and the combination meter 100 can operate as an indicator display device.

### Second Embodiment

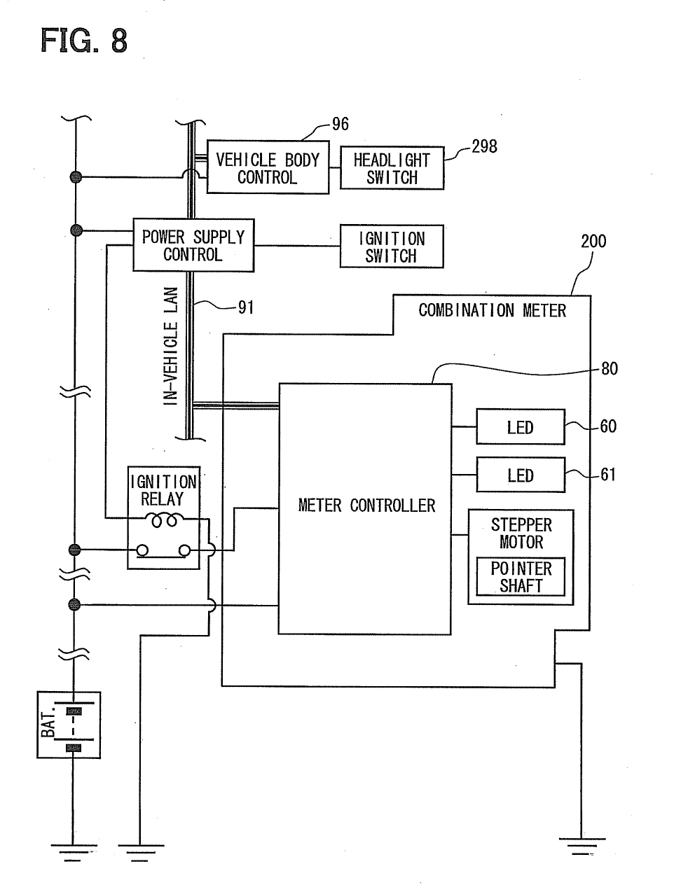

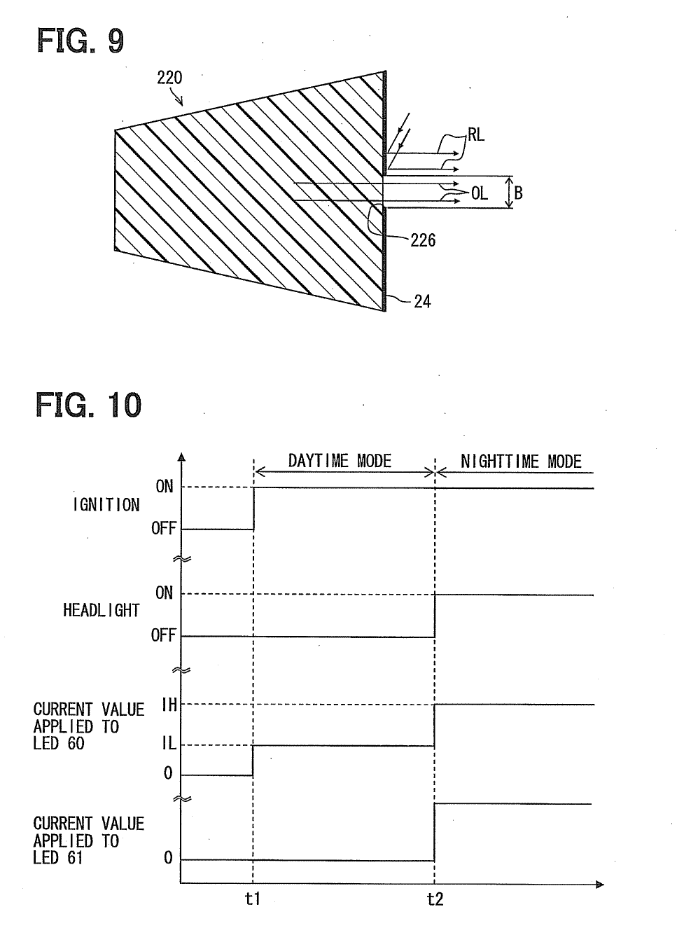

A combination meter 200 according to a second embodiment of the present disclosure will be described with reference to FIG. 8 to FIG. 10. The second embodiment is a modification of the first embodiment. In a vehicle in which the combination meter 200 is mounted, the vehicle body control circuit 96 is coupled with a head light switch 298 instead of the light control sensor 97. The vehicle body control circuit 96 detects an operation to the head light switch 298 by a user and switches an on-off state of a head light of the vehicle. In addition, the vehicle body control circuit 96 transmits information on the on-off state of the head light to the in-vehicle LAN 91.

The combination meter 200 includes an indicator 220 having an exit slit 226. A width B of the exit slit 226 is greater than the width b of the exit slit 26 according to the first embodiment. Thus, the exit slit 226 is visible to a user. The meter controller 80 makes it difficult for a user to view the exit slit 226.

As shown in FIG. 8 to FIG. 10, when the ignition switch of the vehicle is switched from the off-state to the on-state (see time t1 in FIG. 10), the meter controller 80 acquires information on the on-off state of the head light as information on the outside light amount. For example, when the meter controller 80 acquires information that indicates the head light is in the off-state, the meter controller 80 determines that surroundings of the combination meter 200 is not a dark place and sets the lighting mode to the daytime mode. Then, the meter controller 80 applies a predetermined current value IL to the light emitting diode 60 so that the light emitting diode 60 emits the light flux. The current value IL is set so that the light flux density of the output light OL output from the exit slit 226 corresponds to the light flux density of the reflected light RL reflected by the colored layer 24.

When the light flux amount emitted from the light emitting diode 60 is controlled, it becomes difficult for a user to discriminate the exit slit 226 from the colored layer 24 under a condition in which outside light comes in. Thus, the appearance of the indicator 220 covered by the colored layer 24 as if the exit slit 226 is not formed is visible to a user. Also in the daytime mode according to the present embodiment, the meter controller 80 stops the application of electric current to the light emitting diode 61.

When the head light is switched from the off-state to the on-state (see time t2 in FIG. 10), the meter controller 80 acquires information that the head light is in the on-state. The meter controller 80 determines that the surroundings of the combination meter 200 is a dark place and sets the lighting mode to the nighttime mode. Then, the meter controller 80 changes the current value applied to the light emitting diode 60 to a predetermined current value IH that is higher than the current value IL. Accordingly, the light emitting diode 60 emits a sufficient light flux, and the indicator 220 that emits light brightly by outputting the output light OL from the exit slit 226 is visible to a user. Also in the nighttime mode according to the second embodiment, the meter controller 80 applies electric current to the light emitting diode 61 so that the design section, such as the scale portion 12, the figure portion 13, and the unit portion 14 is displayed brightly.

According to the present embodiment, it becomes difficult for a user to view the exit slit 226 in the daytime-mode, and a user can view the indicator 220 that emits light brightly by outputting the output light OL in the nighttime mode. Thus, it becomes difficult for a user to predict a change in the appearance of the indicator 220 by changing the lighting state of the light emitting diode 60.

In addition, the determination of whether the surroundings of the combination meter 200 is a dark place can be performed based on the on-off state of the head light.

In the present embodiment, the combination meter 200 can operate as an indicator display device.

### Third Embodiment

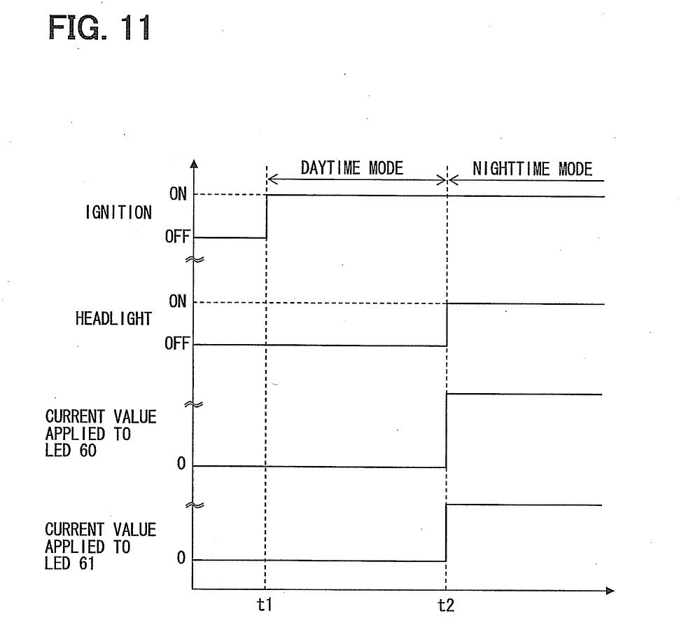

A third embodiment of the present disclosure will be described with reference to FIG. 11. The third embodiment is another modification of the first embodiment. The meter controller 80 according to the present embodiment switches the lighting mode between the daytime mode and the nighttime mode based on the on-off state of the head light in a manner similar to the second embodiment. In the daytime mode according to the present embodiment, the meter controller 80 stops the application of electric current to the light emitting diode 60. Even when emission of the light flux from the light emitting diode 60 (see FIG. 8) is stopped, in a case where the width b of the exit slit 26 of the indicator 20 is set to be smaller than L×tan{1/VP}, a state in which it is difficult for a user to view the exit slits 26 can be maintained. In addition, in the present embodiment, the hue of the light flux emitted from the light emitting diode 60 is set to be different from the hue of the colored layer 24 (see FIG. 5).

In the daytime mode, because it becomes difficult to discriminate the exit slit 26 from the colored layer 24, which are shown in FIG. 5, the appearance of the indicator 20 covered by the colored layer 24 as if the exit slits 26 are not formed is visible to a user. In the nighttime mode, the light emitting diode 60 starts to emit light, and the indicator 20 that emits light by outputting the output light OL from the exit slit 26 is visible to a user. Thus, also in the present embodiment, it becomes difficult for a user to predict the change in the appearance of the indicator 20 by switching the lighting state of the light emitting diode 60 as shown in FIG. 11. Furthermore, in the present embodiment, when the lighting mode is switched from the daytime- mode to the nighttime mode, the hue of the indicator 20 is changed from the hue of the colored layer 24 to the hue of the light flux emitted from the light emitting diode 60. Thus, the change of the appearance of the indicator 20 can be more remarkable.

### Fourth Embodiment

A fourth embodiment of the present embodiment will be described below. The fourth embodiment is another modification of the first embodiment. In a switching process according to the present embodiment (see FIG. 3 and FIG. 4), the meter controller 80 acquires information on the outside light amount detected by the light control sensor 97 as information relating to the outside light amount that reaches the combination meter 100 through the in-vehicle LAN 91 at S101 and proceeds to S102. At S102, the meter controller 80 compares the outside light amount acquired at S101 with a predetermined threshold light amount to indirectly determine whether the surroundings of the combination meter 100 is a dark place.

When the outside light amount detected at S101 is less than the threshold light amount, the meter controller 80 makes an affirmative determination that the surroundings of the combination meter 100 is a dark place where the amount of the outside light is small (S102: YES). Then, the meter controller 80 proceeds to S103 and sets the lighting mode of the combination meter 100 to the nighttime mode. When the outside light amount detected at S101 is greater than the threshold light amount, the meter controller 80 makes a negative determination that the surroundings of the combination meter 100 is not a dark place (S102: NO). Then, the meter controller 80 proceeds to S104 and sets the lighting mode of the combination meter 100 to the daytime mode. After the lighting mode is set at S103 or S104, the meter controller 80 returns to S101 and continues the switching process.

As described above, the information for switching the lighting mode of the combination meter 100 is not limited to the day-and-night determination. By setting the threshold lighting amount for switching the lighting mode of the meter controller 80, the lighting state of the light emitting diode 60 can be switched at an optimum outside light amount for making the change in the appearance of the indicator 20 to predict.

### Fifth Embodiment

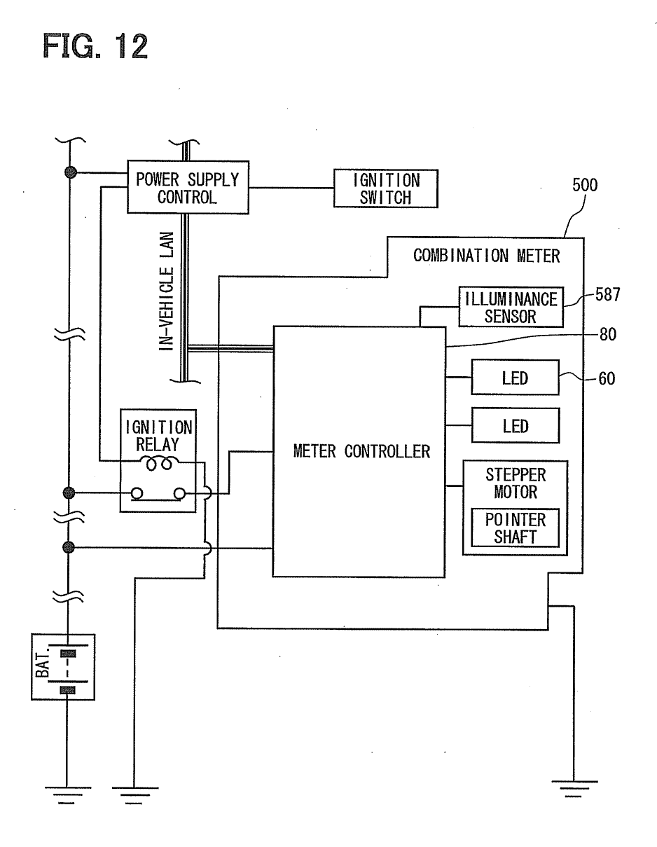

A fifth embodiment of the present disclosure, will be described with reference to FIG. 12. The fifth embodiment is a modification of the fourth embodiment. A combination meter 500 according to the present embodiment includes an illuminance sensor 587. The illuminance sensor 587 has a configuration similar to the light control sensor 97 (see FIG. 3), which is coupled with the vehicle body control circuit 96 in the first embodiment, and is coupled with the meter controller 80. The illuminance sensor 587 detects an amount of outside light that reaches the combination meter 500.

In a switching process according to the present embodiment (see FIG. 4 and FIG. 12), the meter controller 80 acquires information on the outside light amount detected by the illuminance sensor 587 at S101 and proceeds to S102. At S102, the meter controller 80 compares the outside light amount acquired at S101 with a predetermined threshold light amount to directly determine whether surroundings of the combination meter 500 in a dark place where the amount of the outside is small. Then, in a manner similar to the fourth embodiment, the meter controller 80 executes the process at S103 or S104 based on the determination result at S102 and returns to S101.

As described above, the combination meter 500 may include the illuminance sensor 587 for acquiring the information on the outside light amount. By detecting the outside light amount with the illuminance sensor 587, the meter controller 80 can acquire an accurate outside light amount around the combination meter 500. Thus, the meter controller 80 can switch the lighting state of the light emitting diode 60 with a high degree of accuracy at the threshold light amount that is optimally set for making the change in the appearance of the indicator to predict.

In the present embodiment, the illuminance sensor 587 can operate as a detection portion, and the combination meter 500 can operate as an indicator display device.

### Other Embodiments

While the present disclosure has been described with reference to embodiments thereof, it is to be understood that the disclosure is not limited to the embodiments and constructions. The present disclosure is intended to cover various modification and combinations within the spirit and scope of the present disclosure.

In the above-described embodiments, the exit slits 26 are formed in the colored layer 24 by irradiating the colored layer 24 with the laser light. The laser light used in the laser etching for forming the exit slits 26 may be changed appropriately. For example, a carbon oxide gas laser, a semiconductor laser, an infrared laser can be used for forming the exit slits 26. The colored layer 24 irradiated with the laser light is not limited to the printed layer. For example, the colored layer 24 may be formed by hot stamping, coating, plating, and vapor depositing. The colored layer 24 may also be formed on a surface of the pointer 21 other than the visible surface.

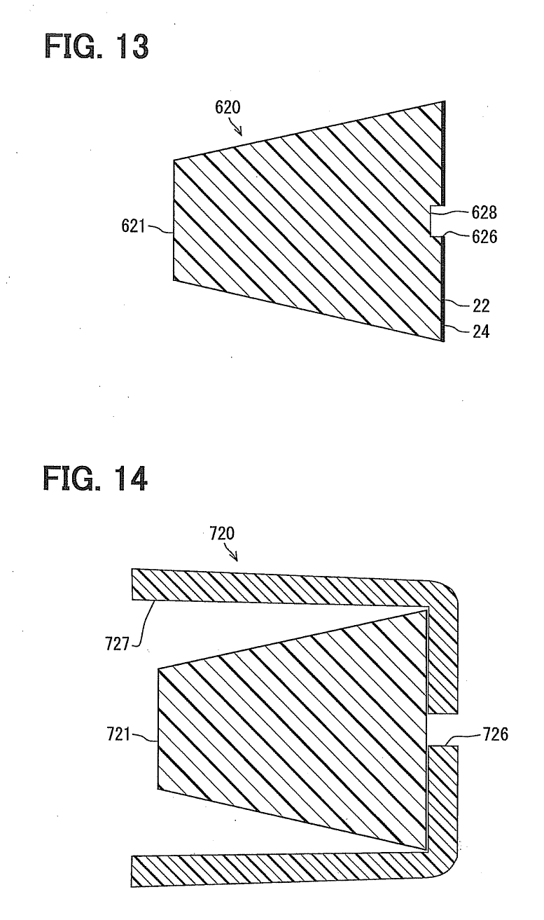

The method of forming the exit slits 26 in the colored layer 24 is not limited to the laser etching. For example, the exit slits 26 may be formed by mechanically removing a part of the colored layer 24. Indicators 620, 720 respectively shown in FIG. 13 and FIG. 14 may be employed instead of the indicator 20.

A pointer 621 in the indicator 620 shown in FIG. 13 includes a depressed portion 628 that extends in a longitudinal direction of the pointer 621. When the colored layer 24 is formed on the visible surface 22 of the indicator 620, a portion of the colored layer 24 facing the depressed portion 628 cannot be attached to the depressed portion 628 and is detached from the depressed portion 628. An exit slit 626 may be formed by detachment of the colored layer 24.

The indicator 720 shown in FIG. 14 includes a pointer 721 and a cover 727 that covers the pointer 721. The cover 727 has an exit slit 726 that extends in a longitudinal direction of the pointer 721. In this way, a light emission of the indicator 720 may be achieved by outputting a light flux from the exit slit 726 formed in the cover 727 that is a different body from the pointer 721.

In the first embodiment, the current value is controlled so that the light flux density of the output light OL corresponds to the light flux density of the reflected light RL based on the predetermined table. A form of data for controlling the current value is not limited to the table. For example, the current value may be controlled based on a function for making the light flux density of the output light OL correspond to the light flux density of the reflected light RL. In the combination meter 500 including the illuminance sensor 587 as the fifth embodiment, it is preferable to acquire information on the outside light amount from the illuminance sensor 587 rather than the light control sensor 97.

In the above-described embodiments, the meter controller 80 that executes the predetermined program with the microcomputer operate as the light source control section, the outside light amount acquisition section, and the determination section. However, configurations operating as the light source control section, the outside light amount acquisition section, and the determination section may be disposed separately from the meter controller in the combination meter. The configurations may operate as the light source control section, the outside light amount acquisition section, and the determination section by executing programs similarly to the meter controller 80 or without programs.

What is claimed is:

1. An indicator display device, comprising:
a light source emitting a light flux; and
an indicator configured to rotate, the indicator including an entrance portion to which the light flux emitted from the light source enters and a shielding portion that blocks transmission of the light flux entering from the entrance portion, the shielding portion having an exit slit from which the light flux entering from the entrance portion is output toward a user,
wherein a width b of the exit slit, an assumed distance L between the indicator and the user, and an assumed visual power VP of the user satisfy a relationship of b(mm)<L(mm)×tan{1/VP(min)}.

2. The indicator display device according to claim 1, further comprising
a light source control section controlling an amount of the light flux emitted from the light source so that a light flux density of an output light that is output from the exit slit corresponds to a light flux density of a reflected light that is an outside light reaching the indicator display device and being reflected by the shielding portion.

3. An indicator display device, comprising:
a light source emitting a light flux;
an indicator configured to rotate, the indicator including an entrance portion to which the light flux emitted from the light source enters and a shielding portion that blocks transmission of the light flux entering from the entrance portion, the shielding portion having an exit slit from which the light flux entering from the entrance portion is output toward a user; and
a light source control section controlling an amount of the light flux emitted from the light source so that a light flux density of an output light that is output from the exit slit corresponds to a light flux density of a reflected light that is an outside light reaching the indicator display device and being reflected by the shielding portion.

4. The indicator display device according to claim 2, further comprising
an outside light amount acquisition section acquiring information on an amount of the outside light reaching the indicator display device,
wherein the light source control section increase the amount of light flux emitted from the light source with increase in the amount of the outside light so that the light flux density of the output light corresponds to the light flux density of the reflected light.

5. The indicator display device according to claim 2, further comprising
a determination section determining whether surroundings of the indicator display device is a dark place where an amount of the outside light is small,
wherein when a determination result of the determination section is negative, the light source control section controls the light source so that the light flux density of the output light corresponds to the light flux density of the reflected light.

6. The indicator display device according to claim 5,
wherein, when the determination result of the determination section is affirmative, the light source control section controls the light source so that the amount of the light flux emitted from the light source is larger than the amount of the light flux emitted at a time when the determination result is negative.

7. The indicator display device according to claim 5, further comprising
an outside light amount acquisition section acquiring information on an amount of the outside light reaching the indicator display device,
wherein the determination section makes an affirmative determination when the amount of the outside light acquired by the outside light amount acquisition section is less than a predetermined threshold light amount.

8. The indicator display device according to claim 5,
wherein the determination section includes a detection portion detecting an amount of the outside light reaching the indicator display device and makes an affirmative determination when the amount of the outside light detected by the detection portion is less than a predetermined threshold light amount.

9. The indicator display device according to claim 1,
wherein the light flux output from the exit slit of the indicator has a hue different from a hue of the shielding portion.

10. The indicator display device according to claim 1,
wherein the light flux output from the exit slit of the indicator has a hue similar to a hue of the shielding portion.
